(19) United States
(12) Patent Application Publication
(10) Pub. No.: US 2009/0047647 A1
(43) Pub. Date: Feb. 19, 2009

(54) SYSTEM AND METHOD FOR BOOK PRESENTATION

(76) Inventor: Meghan M. Welch, Decatur, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 12/191,479

(22) Filed: Aug. 14, 2008

Related U.S. Application Data
(60) Provisional application No. 60/964,831, filed on Aug. 15, 2007.

(51) Int. Cl. G09B 5/06

(52) U.S. Cl. 434/317

(57) ABSTRACT

An electronic book and method of use thereof for reading instruction and entertainment are disclosed, wherein a narration of the story contained in the book may be recorded for subsequent playback during use of the book for reading instruction or entertainment.

### CROSS-REFERENCE AND PRIORITY CLAIM TO RELATED APPLICATION

The present United States Non-Provisional Patent Application cross-references and claims all benefit and priority to related U.S. Provisional Patent Application entitled “System and Method for Book Presentation,” filed on Aug. 15, 2007, having assigned Ser. No. 60/964,831.

### TECHNICAL FIELD

The present invention relates generally to reading and books, and, more specifically, to an electronic book and a method of use thereof for reading instruction.

### BACKGROUND OF THE INVENTION

As many parents know, reading aloud is an effective way of entertaining and educating children of various ages. Hearing a familiar voice can soothe and comfort a child, and reinforces speech and reading development. As such, children of varying ages often request their parents or guardians to read aloud to them for entertainment, and the parents or guardians, knowing the benefits, are obliged to fulfill the request. In some instances, however, the parent or guardian may not be able to devote the necessary time to reading a book to the child. Furthermore, it may not be possible, or practical, to instruct the child to read the book on their own, such as when the child is not yet able to read, or when the child wants to hear a familiar voice read the book aloud.

Furthermore, such book-reading activities do not allow adults who are not present to participate, such as grandparents who live in distant areas, or parents who are away, such as on business or stationed abroad. In these cases, both the child and the absent adult(s) are deprived of the opportunity to share the enjoyable and beneficial experience of reading a book aloud to the child.

Thus, it is clear that there exists an unmet need for a system and method capable of enabling convenient spoken narration of the text of a book by an absent or otherwise preoccupied parent, guardian, or other individual, thereby facilitating reading and speech development, while providing entertainment for one or more child.

### BRIEF SUMMARY OF THE INVENTION

Briefly described, in a preferred embodiment, the present invention overcomes the above-mentioned disadvantages and meets the recognized need for such a device by providing a system and method of book presentation including a customizable book, such as a printed or electronic book having pages, a monitor, or other means for displaying text and/or graphics, and means for recording and playing-back a spoken reading, narration, or other sound, commentary, instruction, or the like.

According to its major aspects and broadly stated, the present invention, in its preferred form, is a book that is customized for a selected user including means for displaying at least one of text and a graphic, and means for playing a is recorded narration, wherein the recorded narration comprises a voice that is familiar to the user.

More specifically, the book can take the form of a conventional paper or cardboard book and an associated recording and playback means, an electronic book in the form of software for use with an electronic display means and an associated or an integral recording and playback means of a personal computer, or a stand-alone electronic device having integrated display means and recording and playback means.

The recording means is preferably used by an individual, such as a parent, a grandparent, or other relative, a guardian, or any other individual, to record a spoken reading of the text of the book, other spoken narration, and/or other auditory element for subsequent playback. By such recording, the book is preferably customized for a selected user who is familiar with the voice of the individual, whereby such familiarity may enhance the entertainment and educational value for the selected user.

During use, the selected user preferably opens the book, either in conventional or electronic form, to a selected page, such as the first page of the book, whereby the user can preferably see text and/or graphics contained thereon. When the book is opened to the selected page, a portion of the recording associated with the selected page is preferably played, whereby the user may preferably listen to the portion of the recording. When play of the portion of the recording is completed, the user may preferably turn the page, such as to a following page, whereby another portion of the recording associated with the following page may be played. Thus, the user may preferably sequentially open each page of the book and listen to an associated section of the recording, whereby the entire recording, or merely preferred portions thereof, may be played to entertain the user and to facilitate speech and reading development by association with the text and/or graphics of the book.

The playback of the recorded portions is preferably automatic upon opening the book to a selected page, but may alternatively be manually activated, such as by pressing a button, whether on a physical device or within a computer program containing the book. Alternatively, the entire recording may play from beginning to end when the book is opened, and stays open.

Accordingly, one feature and advantage of the present invention is its ability to playback a recorded auditory element, such as a spoken reading of text, other narration, or sound, previously recorded by an individual whose voice is familiar to a selected user for whom the recording was made.

Another feature and advantage of the present invention is its ability to allow a reader to read or look at graphics of a book while simultaneously listening to a recorded reading or other narration relating to the text or graphics of the book.

These and other features and advantages of the present invention will become more apparent to those ordinarily skilled in the art after reading the following Detailed Description and Claims in light of the accompanying drawing Figures.

### BRIEF DESCRIPTION OF THE DRAWINGS

Accordingly, the present invention will be understood best through consideration of, and with reference to, the following drawing Figures, viewed in conjunction with the Detailed Description referring thereto, in which like reference numbers throughout the various Figures designate like structure and in which:

FIG. 1a is a perspective view of a customizable book system according to the present invention, showing a first exemplary playback means, a portable headset media device;

FIG. 1b is a perspective view of a customizable book system according to the present invention, showing a second exemplary playback means, a boom box;

FIG. 1c is a perspective view of a customizable book system according to the present invention, showing a printed book;

FIG. 1d is a perspective view of a customizable book system according to the present invention, showing a third exemplary playback means, a personal computer;

FIG. 2 is a perspective view of a customizable book of the present invention according to an alternative embodiment; and

FIG. 3 is a perspective view of a customizable book of the present invention according to another alternative embodiment.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION

In describing preferred embodiments of the present invention illustrated in the Figures, specific terminology is employed for the sake of clarity. The invention, however, is not intended to be limited to the specific terminology so selected, and it is to be understood that each specific element includes all technical equivalents that operate in a similar manner to accomplish a similar purpose.

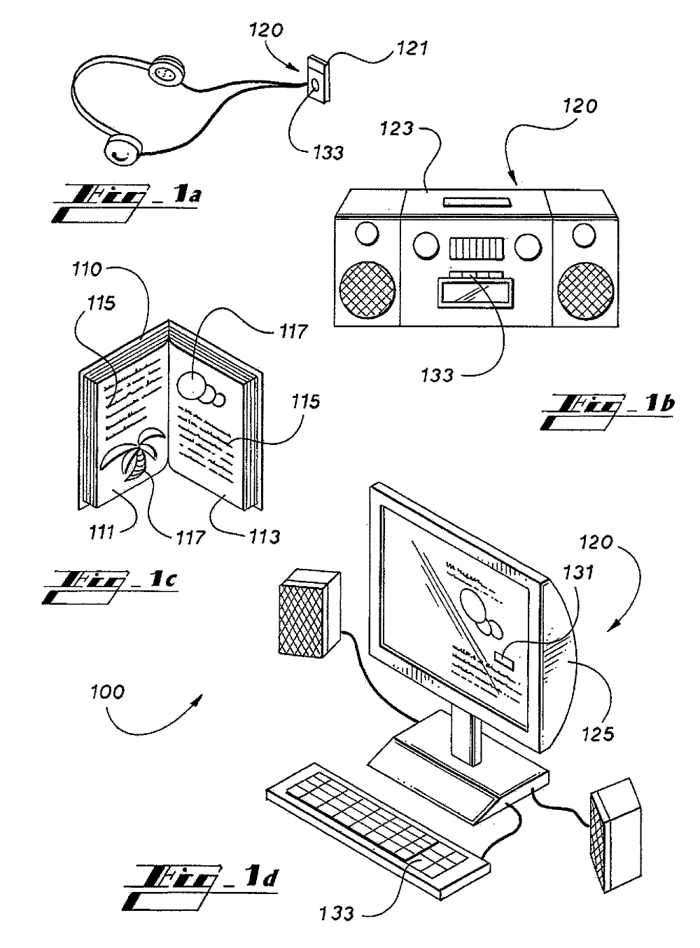

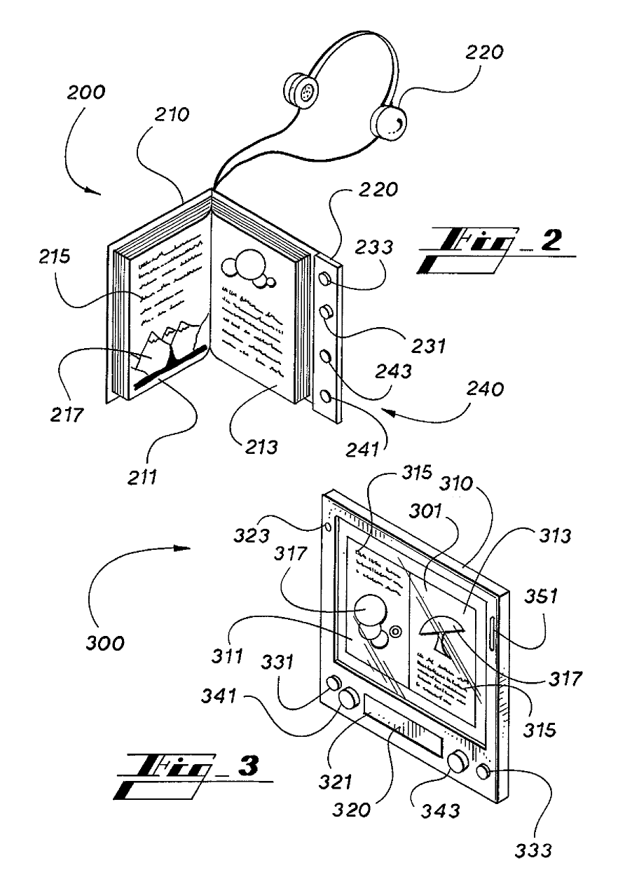

In that form of the preferred embodiment of the present invention chosen for purposes of illustration, FIGS. 1a-1d show the preferred embodiment of the present invention comprising system 100 for customizing a book presentation. System 100 preferably includes printed book 110, such as a paper or cardboard book of conventional construction including pages, such as pages 111 and 113, whereon text 115 and/or one or more graphic element 117 may be presented. System 100 preferably further includes recording and playback means 120 for enabling recordation of a spoken reading, a narration, or other sound, intonation, comment, instruction, or the like, and for enabling playback of such a recording. For example, recording and playback means 120 may include portable playback and/or recording device 121, such as a portable tape player/recorder, a digital recorder and player, a CD player, an mp3 player, or the like.

Alternatively, however, playback and/or recording device 123, such as a component home stereo system, a boom-box, or the like, may be included in system 100, and may be associated with book 110. As a further alternative, personal computer 125 may be used as recording and playback means 120. Finally, and as discussed in more detail below, any one or more of devices 121, 123, and 125 may be used to record the spoken reading, narration, or other sound, comment, instruction, or the like, while the same or another one or more of devices 121, 123, and 125 may be used to playback the recording.

In use, an individual desiring to customize a book, such as a parent, grandparent, guardian, or other individual, including children, obtains system 100 for customization. The individual may then review book 110 to become familiar with text 115 and/or graphics 117 thereof, such as to assist in the generation of a spoken reading, narration, or other sound, comment, instruction, or the like. The individual then preferably uses a first recording and playback means 120 to record an audio component, such as a spoken reading of text 115, a spoken narrative, or another comment, sound, instruction, or the like.

Preferably, the individual uses personal computer 125 to create such a recording using a computer program product. For example, the user may activate the computer program product via a button, such as graphic button 131 displayed on a monitor or button 133, such as that of a keyboard, to initiate, stop, and otherwise control the recording process. The individual may create one or more individual recorded segment of the audio component according to the instructions of the computer program product, or according to their choice. Preferably, the computer program product enables recording of a plurality of recorded segments of the audio component and correlates each such segment to a corresponding section of book 110, such as corresponding chapter, page or group of pages, graphic element, or other section thereof. Alternatively, however, the audio component may be recorded as a single unit, corresponding to the totality of book 110, or one or more sections thereof.

The recording may be done in any format, such as on tape, on compact disc or other disc, or in electronic format, whereby use of an appropriate player enables playback of the recording. Preferably, however, the recording is done in electronic format, such as in mp3 format, whereby each recorded segment may be accessed and played by a computer program product, either automatically or manually, in association with a corresponding section of book 110.

Once the recording is completed and each segment, if any, is associated with a corresponding section of book 110, customization thereof for a particular user is complete. The particular user is preferably related to, or at least familiar with the individual who made the recording, but need not necessarily be so related. The individual may then present book 110 to the user, along with the recording, either integrally included with playback and recording means 120 or separate therefrom, such as on a tape, disk, or other storage medium, such as a flash drive, or electronically, such as via email. The user may then read book 110 while simultaneously listening to the audio component, or the user may alternate between reading a section of the book and listening to a corresponding segment of the audio component, in any desired order. Thus, the user may enjoy hearing the spoken reading or other narration or sounds before, during, or after reading text 115 and/or looking at graphics 117, whereby the user's reading ability and/or enjoyment of book 110 is enhanced by the association of text 115 and/or graphics 117 with the audio component.

To facilitate proper association of the recording with the text 115 or graphics 117 of a given page, a computer program product, either the same as or different than that used to record the audio component, is preferably utilized by the user, whereby the user may indicate what section of book 110 is being used, such that a corresponding segment of the audio component is played back. When the user proceeds to another section, including returning to a previous section, the new section may be indicated and the corresponding segment of the audio component may be played back.

Such indication of the section of book 110 being used by the user may be performed via manual selection of the appropriate corresponding segment of the audio component, such as by selection of tracks of a CD, selection of an mp3, cuing a tape, or via a computer program product, such as by clicking on an icon corresponding to the appropriate section of book 110 or the appropriate segment of the audio component. Alternatively, the indication of the section of book 110 being used by the user may be automatically performed via a connection between book 110 and playback means 120, such as an infrared connection, a radio connection, an electronic connection, a magnetic connection, or the like, whereby an indication signal may be communicated to playback means 120. For example, a sensor within book 110 may provide such indication signal and a communication means may transmit the signal to playback means 120 whereby the segment of the audio component corresponding to a section of the book which is currently open or otherwise being used.

When the user is finished with the book, such as when the user has become a proficient reader, the user may record another audio component, such as their own spoken reading, and return the book to the individual who originally customized the book for their use. Alternatively, the user, or any other individual, may subsequently record a new audio component for use by a new predetermined user, whereby the book may have continued value and ability to facilitate reading comprehension, learning, or entertainment of the new predetermined user.

Now referring to FIG. 2, alternative system 200 for customized book presentation includes book 210, such as a paper or cardboard book similar to that of book 110, and recording and playback means 220. Book 210 preferably includes text 215 and/or at least one graphic element 217 on pages 211 and 213. Book 210 preferably further includes indication means 240 in the form of one or more button 241 and 243 for indicating to integrated recording and playback means 220 a page or other section of book 210 being used. Alternatively, indication means may be formed as a sensor, or the like, whereby a segment of an audio component corresponding to the page or other section of book 210 may be played back or recorded as desired, through a transducer means, such as headphones, a microphone, or other transducer.

As discussed, indication means 240 may be formed as a sensor, whereby a page or other section of book 210 in use may be indicated automatically for use in selecting a corresponding segment of an audio component. Such sensor may be formed as a plurality of piezoelectric, piezoresistive, magnetic, optic, or other sensors associated with each page of book 210, whereby one or more pages to which book 210 is open may automatically be indicated via a signal, such as an electronic signal. For example, a first strip of piezoresistive material may be associated with a page, such as page 211 of book 210, and a second strip of piezoresistive material may be associated with another page, such as adjacent page 213 of book 210. When book 210 is open to adjacent pages 211 and 213, the first piezoresistive strip may exhibit an electrical resistance greater than, or less than, an electrical resistance exhibited by the second piezoresistive strip due to a tensile force applied to one of the piezoresistive strips and a compressive force applied to the other piezoresistive strip due to the relative positions of pages 211 and 213. Alternatively, magnetic material associated with each page may alter an output of a hall-effect sensor associated with a cover of book 210 depending on whether a corresponding page is disposed adjacent the front cover or the back cover.

Alternatively, a user may indicate a section of book 210 in use via one or more button. For example, the user may press button 241 corresponding to a first section of book 210 in use, whereby a signal is transmitted to playback and recording means 220, such that in a recording mode, a spoken reading, narration, or other sound may be recorded as segment of an audio component, and may be associated with the indicated section of book 210. Similarly, in a playback mode, such signal may cause a segment of an audio component associated with the indicated section of book 210 to be played back for the user's educational benefit and/or enjoyment. Each of the one or more button 241 and 243 may be associated with a corresponding section of book 210 in use, such as a page, chapter, or other section, or, alternatively, repeated activation of a single button may be used to indicate the appropriate section of book 210 in use, such as by cycling through each section, in order, from front to back. Likewise, one of the playback mode, the record mode, an off mode, a sleep mode, or other mode may be selected by activation of a corresponding button 231 and 233, switch, or other signaling or control device to cause recording and playback means 220 to operate in a desired mode, whereby customization, use, battery-conservation of system 200, or the like, may be carried out.

As such, system 200 for customized book presentation may be a stand-alone system, wherein an individual may record an audio component, in one or more segments, thereby customizing book 210 for subsequent use by a selected individual via playback of the audio component to facilitate reading development and/or comprehension, entertainment, or the like. The audio component may be created including one or more segment thereof, each segment being associated with a corresponding section of book 210, via playback and recording means 220 and an associated microphone, or other sound transducer, during customization. One or more selected segment may likewise be played back, in any selected order, via playback and recording means 220 according to a signal indicating a section of book 210 in use.

Now referring to FIG. 3, alternate system 300 for customized book presentation may be formed as an electronic book, or e-book, 310, including integrated recording and playback means 320, formed as one or more speakers 321 and at least one microphone 323. Pages 311 and 313 may be formed as portions of display screen 301 including text 315 and/or one or more graphic element 317 thereon. Each of recording and playback means 320, user control buttons 331, 333, 341 and 343, and mode-selection means 351 is preferably formed as an integrated component of electronic book 310, whereby all the functions of electronic book 310, similar to those described above with respect to systems 100 and 200, and as described in more detail below, are performed by electronic book 310 without the need for any additional associated components, devices, or the like.

As will be understood by those ordinarily skilled in the art, system 300 may be formed as a computer, whether stationary, such as a desktop computer, whether portable, such as a laptop computer or other mobile electronic device (including PDAs, cellular phones, MP3 players, CD or DVD players, or the like), or whether combinations of stationary and portable computers. Additionally, system 300 may be formed as a dedicated device made specifically to carryout the methods of customized book presentation disclosed herein.

As such, electronic book 310 may be customized by allowing recording on a storage medium thereof (not shown), such as a hard drive, a flash drive, a tape, or the like. Such recording may be performed by an individual via operation of mode-selection means 351, preferably formed as a selector switch, to select a record mode. Such selection of the record mode preferably initiates a recording computer program product executed by a processor means (not shown). When in the record mode, the individual may select a page or other section of electronic book 310 to customize via user control buttons 341 and 343, activation of which respectively advances and returns a section of electronic book 310. When a desired section of electronic book 310 is selected, the individual may customize the section by recording a segment of a spoken reading, narration, or other sound, comment, instruction, or the like, associated with the selected section of electronic book 310 by activating user control button 331 to initiate recording and by activating user control button 333 to stop recording when the segment of the spoken reading, narration, or other sound, comment, instruction, or the like is completed.

The individual may then select another section of electronic book 310, such as a subsequent section, via user control buttons 341 and/or 342, and repeat the recording process described above to create another segment of the spoken recording, narration, or other sound, comment, instruction, or the like associated with the selected section of electronic book 310. Thus, each desired section of electronic book 310 may be customized with an associated recording by the individual. The customized electronic book 310 may then be presented to a user, such as a child who is preferably familiar with, related to, or otherwise connected to the individual, for use in facilitating reading comprehension or learning and/or for entertainment of the user.

In use by the user, mode-selection means 351 may be used to select a playback mode, in which a desired section of electronic book 310 may be selected for display via activation of user control buttons 341 and/or 343. A segment of the recorded spoken reading, narration, or other comment, sound, instruction, or the like associated with the selected section of electronic book 310 may be played back either automatically upon selection, or upon activation of user control button 331 and/or 333. As desired, the user may select additional sections of electronic book 310, and playback associated segments of the recorded spoken reading, narration, or other sound, comment, instruction, or the like.

As will be understood by those ordinarily skilled in the art, book 110, 210, and/or 310 of the present invention may be formed as a photo album, a scrap book, a reference book, a text-book, or other non-fiction work, as a novel, one or more poem, a comic book, a magazine, or the like, and text elements 115, 215, and/or 315 and/or graphic elements 117, 217, and/or 317 may take any form desired.

In an alternate embodiment, the recorded reading or narration for one or more segments of electronic book 310 may be performed by a different reader than another segment. In such manner, for example, a child could be given a book with each section or chapter read and recorded by a different member of the child's family.

Having thus described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A book that is customized for a selected user comprising:
means for displaying at least one of text and at least one graphic; and
means for playing an audio component,
wherein said audio component comprises a voice that is familiar to the selected user by association unrelated to said book.

2. The book of claim 1, wherein said audio component comprises at least one segment, and wherein said segment is associated with a corresponding section of said book.

3. The book of claim 2, wherein said means for playing an audio component plays one said segment of said audio component corresponding to one said section of said book upon receiving an indication that said section is being used.

4. The book of claim 1, further comprising means for recording said audio component.

5. The book of claim 4, wherein said means for recording said audio component records a segment of said audio component and associates said segment of said audio component with a corresponding section of said book.

6. The book of claim 4, wherein each of said means for recording said audio component and said means for playing said audio component are integrally associated with said means for displaying.

7. The book of claim 1, wherein said means for playing said audio component is integrally associated with said means for displaying.

8. The book of claim 1, wherein said means for displaying comprises a conventional book having a plurality of pages.

9. A method of making a customized book comprising the steps of:
obtaining a book comprising at least one of text content and graphic content;
creating a recording of an audio component related to at least one of said text content and said graphic content to customize said book for a selected user; and
associating said audio component with said book,
wherein said step of creating a recording is performed by an individual whose voice is familiar and who is personally known to the selected user, whereby said audio component may be played by the selected user.

10. The method of claim 9, wherein said audio component comprises at least one of a spoken reading of said text content and a spoken narration of at least one of said text content and said graphic content.

11. The method of claim 9, wherein said step of creating a recording comprises recording a first segment of said audio component corresponding to a first section of said book, and recording a second segment of said audio component corresponding to a second section of said book.

12. The method of claim 11, wherein said step of associating said audio component with said book comprises associating said first segment of said audio component with said first section of said book, and associating said second segment of said audio component with said second section of said book.

13. The method of claim 12, wherein the selected user provides an indication of one said section of said book in use, and wherein one said corresponding segment of said audio component is played in response to said indication.

14. The method of claim 13, wherein said indication is automatically provided upon use of said section of the book.

15. A method of using a customizable book to facilitate reading comprising the steps of:
recording an audio component for a selected user using a voice personally known to the selected user; and
playing said audio component while the selected user reads the customizable book,
whereby the selected user's reading is facilitated by said step of playing said audio component and listening to the personally known voice.

16. The method of claim 15, wherein said audio component comprises one of a spoken reading of a text component of the customizable book and a spoken narration of at least one of said text component and a graphic component of the customizable book.

17. The method of claim 15, wherein said step of recording is performed by an individual whose voice is familiar to the selected user, and wherein said customizable book is customized for the selected user via said step of recording.

18. The method of claim 16, wherein said step of recording comprises recording a first segment of said audio component corresponding to a first section of the customizable book, and recording a second segment of said audio component corresponding to a second segment of the customizable book.

19. The method of claim 18, wherein said step of recording further comprises associating said first segment with said first section, and associating said second segment with said second section.

20. The method of claim 17, wherein the selected user's familiarity with the voice of the individual facilitates the selected user's comprehension of at least one of a text component and a graphic component of the customizable book.
